(19) United States
(12) Patent Application Publication
(10) Pub. No.: US 2015/0193389 A1
(43) Pub. Date: Jul. 9, 2015

(54) PRESENTING UPDATED HYPERLINK INFORMATION ON A WEBPAGE

(71) Applicant: Robert Brett Rose, Boulder, CO (US)

(72) Inventor: Robert Brett Rose, Boulder, CO (US)

(73) Assignee: GOOGLE INC., Mountain View, CA (US)

(21) Appl. No.: 13/413,596

(22) Filed: Mar. 6, 2012

(51) Int. Cl. G06F 17/22; G06F 17/30

(52) U.S. Cl. CPC G06F 17/2235; G06F 17/2247; G06F 17/30887

(57) ABSTRACT

A dynamic and on-demand determination is made of whether a link on a web page is inactive, and if so, it is automatically updated with an alternate link, if possible. If no alternate link is available, the link is removed. A cue is provided to the user regarding the current status of the links. This Abstract is submitted with the understanding that it will not be used to interpret or limit the scope or meaning of the claims.

### BACKGROUND

Many web pages have broken links, or links that take a user to outdated or irrelevant information. Existing web pages can link to other pages without the user knowing (or caring) what pages are linking in. When a website becomes dormant, changes the content, renames pages, or simply becomes unresponsive, the incoming links from other web pages may not work properly. Some sites give a helpful message if an incoming link does not resolve to a page on the site, some sites redirect, but most sites just return an error message (e.g. HTTP 404 response). This is frustrating to the user and provides a poor user experience.

### SUMMARY

The implementations described herein provide a dynamic and on-demand determination of whether a hypertext link is inactive or has been replaced with one or more alternate links, and provide a cue to the user regarding the current status of the links. An apparatus enables user notification regarding status of a link of a web page. The apparatus includes a disambiguation utility configured to receive one or more link destination addresses present on the web page when a user accesses the web page. The disambiguation utility attempts to ping each of the one or more link destination addresses after the user accesses the web page, and return a modified list of links for presentation to the user that include one or more of active and responding links or alternate links in the case of inactive links or irrelevant links. A delinkifying utility is configured to delinkify each link discovered to be inactive after the attempt to ping each of the one or more link destination addresses by the disambiguation utility. A link updating utility is configured to return a modified list of links including one or more of inactive links, active links, or alternate links, or some combination thereof, for presentation to the user in a manner that reveals to the user the status of the links.

This Summary is not intended to introduce key features or essential features of the claimed subject matter, but merely provides a selection of concepts that are further described in the Detailed Description. Further implementations, features, and advantages, as well as the structure and operation of the various implementations are described in detail below with reference to accompanying drawings.

### BRIEF DESCRIPTION OF THE DRAWINGS

Implementations are described with reference to the accompanying drawings. In the drawings, like reference numbers may indicate identical or functionally similar elements. The drawing in which an element first appears is generally indicated by the left-most digit in the corresponding reference number.

FIG. 1 is a schematic diagram of a system configured to provide current and relevant links on a web page and on-demand notification to a user of the status of the links.

FIG. 2 is a schematic diagram of a system with multiple client devices accessing multiple web pages through networks and a server.

FIG. 3 is a flow chart of techniques for updating links on web pages and notifying a user of the status of the links.

FIG. 4 is a schematic diagram of an example computer system for implementing one or more embodiments of the disclosure.

FIGS. 5A and 5B illustrate examples of notifications presented on a client interface in accordance with one implementation of the disclosure.

### DETAILED DESCRIPTION

Implementations of this disclosure enable an improved web surfing experience by dynamically providing a user with updated and relevant links on a web page after the user navigates to the web page, and visually presenting the updated information to the user inline with the page. The implementations and techniques described herein provide a dynamic and on-demand determination of whether a hypertext link on a web page is inactive or has been replaced with one or more alternate links, and provide a cue to the user regarding the current status of the links. When a user opens a web page, the client initially renders the web page normally with all of the links on the page appearing as usual.

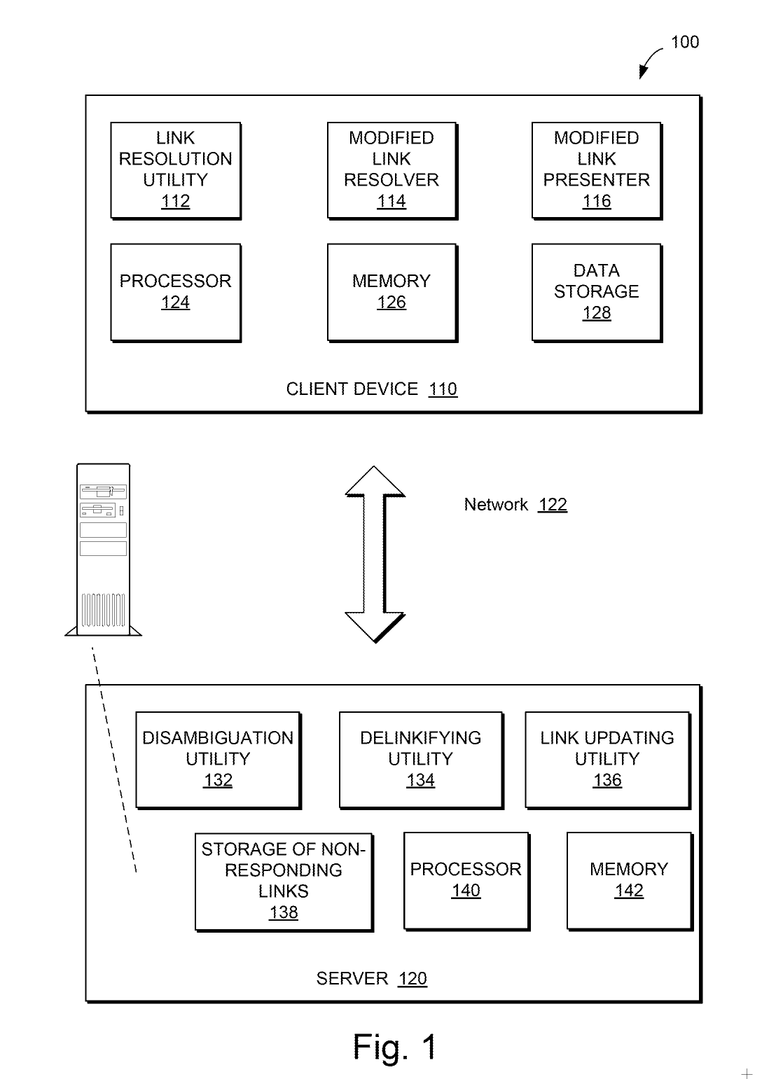

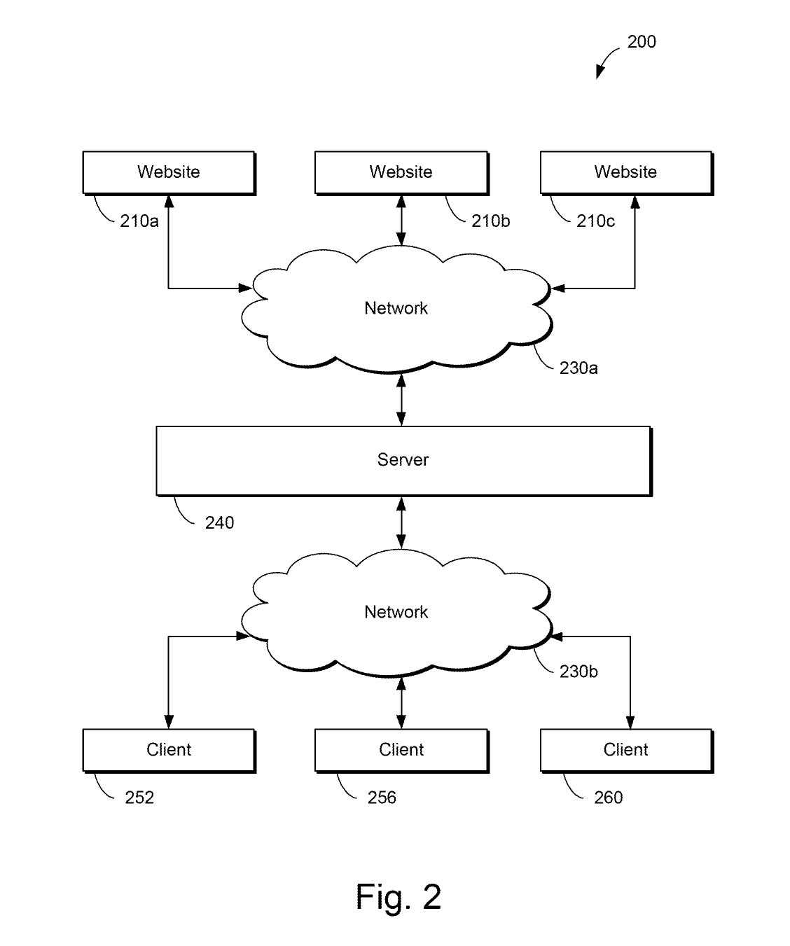

As shown in FIG. 1, a link resolution utility 112 of client device 110 then creates a list of all of the links on the page with their uniform resource locator (URL) destination addresses and other attributes of the anchor tags associated with each of the links. This list can be sent to a server to be processed, or processed right on the client device in the background. FIG. 2 illustrates multiple client devices 252, 256, and 260 communicatively coupled to a server 240 over a network 230b. Connections can occur across this communicative coupling when a user clicks on a link in a document being presented on a client device. A link provides a hypertext markup language (HTML) uniform resource locator (URL) destination address that results in navigation from the source document with the link to a target document at the destination address on a web site such as web sites 210a, 210b, and 210c through the communicative couplings over networks 230a and 230b.

The processing of the list of links originally presented on a web page is performed by a disambiguation utility 132, as shown in FIG. 1. Although the disambiguation utility 132 is illustrated as part of the server 120, this utility, or a module performing the functionalities of the utility, could be included as part of the client 110 or the server 120. The processing by the disambiguation utility 132 occurs in the background when a user accesses the webpage, and can be done asynchronously and dynamically. Asynchronous processing means that the actions being performed by the processor do not have to occur at predetermined or regular intervals. Dynamic processing is processing that does not occur statically, but rather occurs as a result of a change in situation, such as, e.g., the user accessing the webpage. The disambiguation utility 132 checks each one of the links in the list of links to determine if an attempt by the client to navigate from the source document containing the link across one or more networks such as networks 230a and 230b in FIG. 2, to a target document at the uniform resource locator (URL) destination address of the link somewhere on the world wide web, will be successful.

If the disambiguation utility 132 determines that a link is inactive, further searching may be performed by a link updating utility 136, also shown in FIG. 1, to attempt to find an alternate, active link that connects to contextually relevant information. An inactive link is one that receives an HTTP 404 response code (an error code), gets redirected, receives no response, results in the wrong type returned, too many redirects, etc.

In some situations, a receiving web server may respond to a ping even if the specific page is not readable. If a page responds to the ping, the next step in an algorithm performed by the link updating utility 136 may be to send an HTTP ‘HEAD’ request, which returns the metadata or summary data about the site. The response code will indicate if the actual page is available. The response code will be examined and the algorithm will do the following based on the response code:

1xx (all 100 codes): All is well, the link is considered ok
2xx (all 200 codes): Same as all 100 codes
3xx (all 300 codes): These are all redirect statuses, but since the server
usually has a redirect URL that it supplies to the client, this is transparent
to the user, so the effect is the same as for all 100 codes and 200 codes.
For all 100-300 codes, no link changes are done, but the link should
be checked against the list of dead links and removed from the list if
found.

The 4xx response codes (all 400 codes): These are all error codes. This is when the link is considered dead and should be replaced. The link should be added to the dead link list.

The 5xx response codes (all 500 codes): These indicate that a server error occurred. The link may in fact be fine, but something prevented the server from processing the request at this time. For these responses, the link should be considered dead, but not added to the dead link list as the non-responsive link may be a transient failure.

The meta-information associated with the tag for the inactive link, which has been sent to the disambiguation utility 132 by the link resolution utility 112, can be used by the disambiguation utility 132 and the link updating utility 136 to improve the chances of finding a useful alternate link. Such meta-information includes, but is not limited to, identification information, domain name, alt-text, help menus, and other parameters. If no alternate links are found for an inactive link, then the link updating utility simply returns the finding of no alternate link. If an alternate link for an inactive link is found, the link updating utility returns the alternate link to the client.

The link updating utility 136 returns the modified list of links, or information that a link is inactive and no alternate links could be found, to a modified link resolver 114 of client 110, as shown in FIG. 1. The modified list of links may include active and responding links, for which navigation to a currently active and relevant target document was successful, and alternate links in the case of non-responding, inactive, or irrelevant links. The modified link resolver 114 is configured to resolve the differences from each of the originally presented links on the web page, including information that non-responding links are inactive, and that alternate links are provided to replace inactive links when available. A modified link presenter 116 on the client device 110 then presents the modified list of links to the user.

The user experience is enhanced as a result of this dynamic and on-demand update of the links visible to the user when accessing a web page. The updating process occurs in the background when the user opens the web page, and can be performed by the disambiguation utility 132 and link updating utility 136. Although FIG. 1 shows the disambiguation utility 132 and link updating utility 136 as part of the server 120, these utilities could just as well be part of a browser, or a browser extension on the client, as part of one or more servers, or performed by one or more modules providing the functionality of the disambiguation utility and link updating utility and distributed across one or more clients and/or servers. The updating process occurs dynamically when the user navigates to a web page with links, possibly before the user even attempts to click on any of the presented links. Therefore, the user sees currently links that have been verified as active, or for inactive links, information that the link is inactive, with a possible alternative link. With this information, the user does not have to waste time or the frustration of clicking on dead or irrelevant links that do not result in navigation to any useful information, or simply result in an error message.

The user experience is further enhanced by providing a visual or other cue to the user that a link is inactive, or that an alternative link has been provided. The visual cue can be provided by modifying hyperlinks at runtime using programming script. Inactive links can have a change in appearance when a pointer is hovered over the link, with the link being rendered inactive. Alternate links could also be modified such that the link is still active, but the user is presented with a textual notification that the link has been updated when hovering a pointer over the link. A modified link presenter 116 on the client device 110 thus shows the user the status of the link and what has been done to rectify the situation. The described techniques may be implemented on a client application such as a web browser (or a browser extension), on a server, or on some combination of both.

### Example Processing Features

The systems and techniques employed to achieve various aspects of the disclosure include: 1) Client processing features 2) Server processing features; and 3) Client user interface enhancements to show results. While the following example implementations may be described in terms of features or functionalities that are contained in, or performed by a client, or a server, the same features could be contained in, or performed by either a client or a server, or some combination of both.

### Client Processing Features

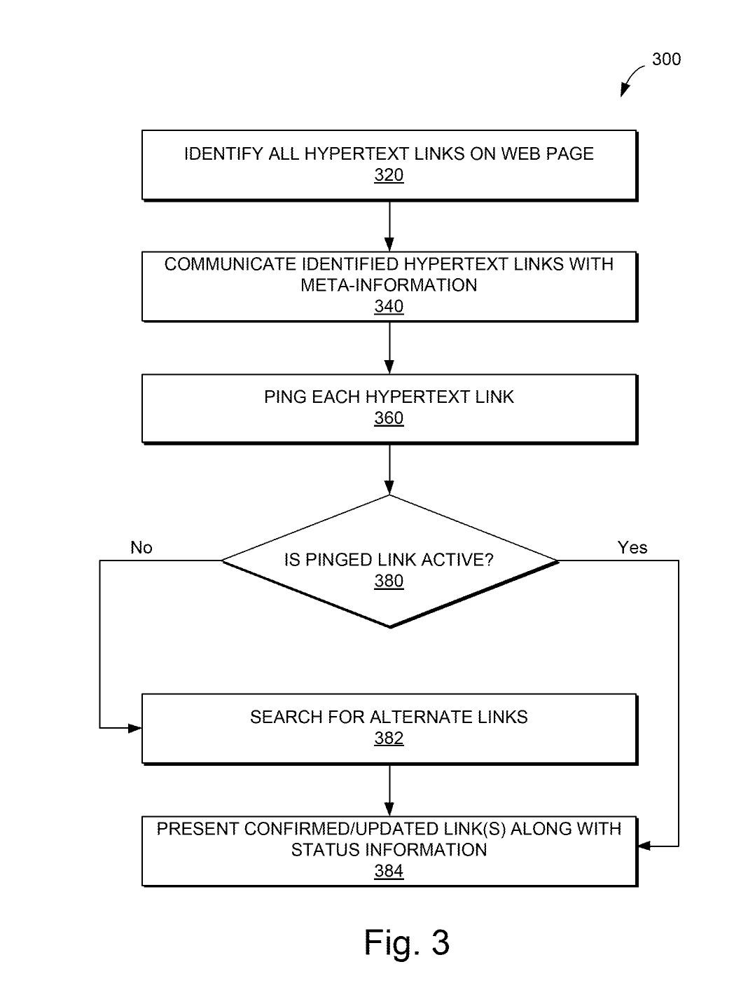

As shown in step 320 of FIG. 3, the browser or other client application or extension initially renders a hypertext markup language (HTML) page normally on the client device through a user interface, assuming all the hypertext links are valid. As shown in FIG. 1, the client device 110 includes a link resolution utility 112 configured to create a list of the hypertext reference (href) uniform resource locator (URL) addresses on the current web page that has just been accessed by a user. The link resolution utility 112 gathers together these URL addresses, as well as other attributes in the anchor tags associated with each URL address. Other link reference types besides href links from anchor tags could also be gathered by the link resolution utility 112. Examples could include image references (<img> tags), background images in css (background-image: url(‘ . . . ’)), flash references (*.swf), etc. As an alternative to creating a list of hyperlinks from the current web page accessed by a user, with or without associated attributes, the link resolution utility 112 may simply send the URL for the web page itself, with all of the links included on the web page.

As shown at step 340 of FIG. 3, and in FIG. 1, this information is combined in one message and communicated over a network 122 to a server 120 for analysis and processing. The anchor text and other attributes may be sent to the server 120 in order to assist in link resolution.

### Server Processing Features

As shown at step 360 in FIG. 3, and in FIG. 1, a disambiguation utility 132 on the server 120 takes the list of links from the client 110 and tries (pings) each one in an attempt to navigate from the source document on the web page accessed by the user to one or more target documents located at the URL destination addresses of the links on the world wide web. Pinging of a web site merely checks if the site responds, and can occur very rapidly since the site is not actually read, parsed, analyzed, or otherwise processed. The pinging of a plurality of links can be done in parallel by the server 120. For each link that is not responding, the server 120 may perform several operations:
a) Note the date and time of non-response and add to a list of non-responding links maintained in storage 138, or if the link is already on the list of non-responding links, update a date/time and count; and
b) Try to find an alternate URL on the same site, or a different site.

Non-responding links may be recorded in storage 138 so the server 120 can keep track of URLs that no longer work. After a number of non-responses, the URL for the non-responding link is added to a list of known dead links. The list may be checked before pinging a link on a newly opened web page to save time, and to save the user from the frustration of receiving an error message when attempting to navigate to a valid target document from a dead link. A dead link doesn't have to be checked each time, but periodically, links on this list may be retried to see if the link comes back. The retries could be timed and spaced so as to not burden the hosting websites unnecessarily. Dead links that keep coming back as non-responsive can be checked less and less frequently.

After pinging the links, the disambiguation utility 132 of server 120 passes information on the status of the links to delinkifying utility 134 and link updating utility 136. As shown at steps 380 and 382 of FIG. 3, if a pinged link is non-responding or inactive, the link updating utility 136 may perform a search for alternate links, using information received by disambiguation utility 132 from link resolution utility 112, such as the metadata or summary data associated with the anchor tag of the inactive link. Delinkifying utility 134 removes the link attribute from non-responding or inactive links by techniques including, but not limited to, modifying the scripting language associated with the link to place a non-click handler on the link.

As discussed above, although the features or functionalities of the disambiguation utility 132, the delinkifying utility 134, and the link updating utility 136 are described in terms of features or functionalities that are contained in, or performed by a server, the same features or functionalities could be contained in, or performed by a client.

As shown at step 384 of FIG. 3, after processing the list of links that were originally present on the web page, the server 120 responds to the client 110 with either an OK message (all links are good) or a list of alternate links for links that are non-responsive. For each bad link, if an alternate link cannot be found, the server will also provide that information. The entire updating process performed on the list of links originally present on a web page accessed by a user occurs rapidly in the background so that the user is not even aware of the process. The user enjoys the benefits and improved user experience achieved by the presentation of a dynamically updated list of links.

One method of resolving a link that is not responding, or that returns a non-contextual reference, is to use a database of web pages in the same site, available from any of a number of web-indexing services. The links can be looked at from the same top level domain (TLD), looking for a close match based on the URL names and titles of the pages. As one example, a link to matchboxcars.com/trucks/1970FordPickup.htm may be determined to be dead or non-responsive. A search of the site index may turn up the following files:

trucks/1970ChevyPickup.html

trucks/1970FordPickup.html

trucks/1970DodgePickup.html

trucks/1970ToyotaPickup.html

By doing simple string matching, the trucks/1970FordPickup.html is the closest match and would be used as the replacement. This is an example of a webmaster changing the extension or renaming the files.

Another step of a search algorithm employed to find contextually relevant links when one link is found to be non-responsive could be to move up the page hierarchy. In the above example, if none of the filenames where a close match, but there was found to be a trucks/index.htm (or .html) page, then that index page which might be expected to be about trucks in general, could be used as the substitute. Instead of using a specific page, the more general page that is closely related to the dead page would be used. This algorithm recursively moves up the hierarchy, so the fallback would be to show “matchboxcars.com” as the replacement URL for any URL where it can't find a better choice.

### Client User Interface Enhancements

As shown in FIG. 1, a modified link resolver 114 of client 110 receives updated link information. This updated link information can be received over network 122 from the server 120, or in the case when the disambiguation utility 132 and link updating utility 136 are included as part of the client, the updated link information is received directly from these utilities on the client. The modified link resolver 114 of client 110 processes this information to determine the differences, if any, from the link information first available on a web page when the client connects to the web page. If the client 110 gets an OK response after the disambiguation utility 132 has checked each of the links, no further action is required. If there are any bad links on the page, in accordance with various implementations of the disclosure, the modified link resolver 114 of the client 110 resolves the updated information by delinkifying inactive links with no alternate links, and substituting the discovered alternate links where appropriate. These changes are communicated to the user through modified link presenter 116. The modified link presenter 116 can be part of the browser, or a browser extension using content scripts on the client 110. The actual substitution of discovered alternate links can be done directly by the browser (e.g. rendered) or through script inserted by the browser.

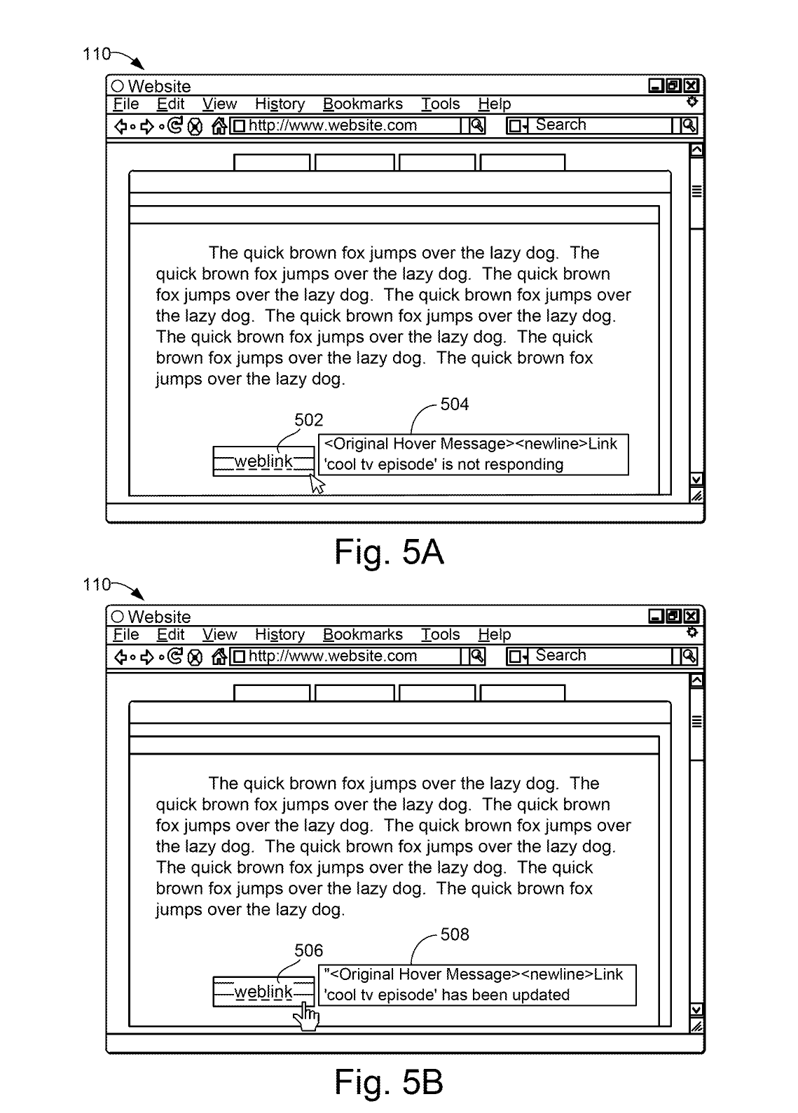

Because it could be confusing to a user to merely replace the href URL address for a link that has been replaced with a new address of an alternate link, the modified link presenter 116 of the client 110 can present the new URL address or link in a way that notifies the user of the change. As shown in FIG. 5A, if a link is found to be dead and no alternates are available, the modified link presenter 116 causes the user interface (UI) of the client device 110 to show this in a visibly distinguishable manner. One non-limiting example of such a visibly distinguishable presentation is to provide dotted or dashed underlining under the text 502. Additional and/or alternative ways of providing a user with visual cues that a link is inactive, or that an old link has been replaced with alternative links, can include providing different fonts, different colors, bolding, italicizing, etc.

The modified link presenter 116 is further configured to update the hover attribute of a modified link to show an additional textual message to the user. As shown in FIG. 5A, one non-limiting example of such an updated hover attribute could be “<Original Hover Message><newline>Link ‘cool TV episode’ is not responding”. This textual message 504 notifies the user that a link is present but not functional at this time. The text would not be “linked” so the mouse pointer will not change on hover as it does over a valid, working link.

As further shown in FIG. 5B, in a situation where one or more alternate links have been found and returned by disambiguation utility 132 and link updating utility 136, the modified link presenter 116 may be further configured to distinguish the text of a modified link 506 with markings such as a dotted or dashed underline, while retaining the link attribute. The text for such alternate links could act just like any other link, highlighting or changing color on a mouse hover, and the pointer would change on hover as well. A hover text message 508 may be updated to show the original hover text (if any) along with a message like, “<Original Hover Message><newline>Link ‘cool TV episode’ has been updated”. When the user clicks on the link, the user would be taken to the new address. The distinguishing markings such as dotted or dashed underlining under the linked text, as well as the updated hover messages, ensures the user knows that the links have been examined and updated.

Another feature that can be incorporated into one or more of the modified link resolver 114 and the modified link presenter 116 is functionality that enables requesting and accepting feedback from the user regarding the usefulness of the discovered and presented alternate links. Such feedback from the user can be used by the link updating utility 136 of server 120 as additional information to help decide if an alternate link is useful or not. The modified link presenter 116 could be configured to provide a small thumbs-up or thumbs-down icon that would appear when hovering the pointer over a modified link, such that the user could select the appropriate icon depending on whether they are satisfied with the alternate link. The user's feedback would get sent back to the link updating utility 136 of server 120 to help improve the results obtained by the link updating utility.

As shown in FIG. 1, in addition to the link resolution utility 112, the modified link resolver 114, and the modified link presenter 116, the client device 110 has one or more processors 124, memory 126, and storage 128. The server 120 may include the disambiguation utility 132, delinkifying utility 134, link updating utility 136, storage 138, one or more processors 140, and memory 142. Alternatively, as discussed above, some or all of the components, including the disambiguation utility 132, the delinkifying utility 134, and the link updating utility, may be included as part of the client device. The components introduced above may be implemented as a combination of suitable electronic components, which may include hardware, firmware, software, and/or a combination thereof. For example, portions of each component introduced above may be implemented as a program module with processor-executable instructions that may be stored in memory 126 of client 110 or memory 142 of server 120 and executed by the one or more processors 124 of client 110 or processor(s) 140 of server 120. Of course, the client device may have other components and functions that are not depicted. Furthermore, some or all of the components could be contained within a server or within a plurality of servers instead of, or in addition to the client device.

While example implementations herein are described in connection with software, hardware, or a combination thereof residing on one or more client devices, server, etc., one or more portions of the disclosed techniques and systems may also be implemented via an operating system, application programming interface (API) or a “middle man” object between any of the one or more processors on the various client devices and server.

The technology described herein may be deployed in part or in whole through a machine that executes computer software, program codes, and/or instructions on one or more processors contained in the client devices and/or the server. Implementations of the disclosure may include a method on a machine, a system or apparatus as part of or in relation to the machine, or a computer program product embodied in a computer readable medium executing on one or more of the machines.

The one or more processors may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

### Example Computer System

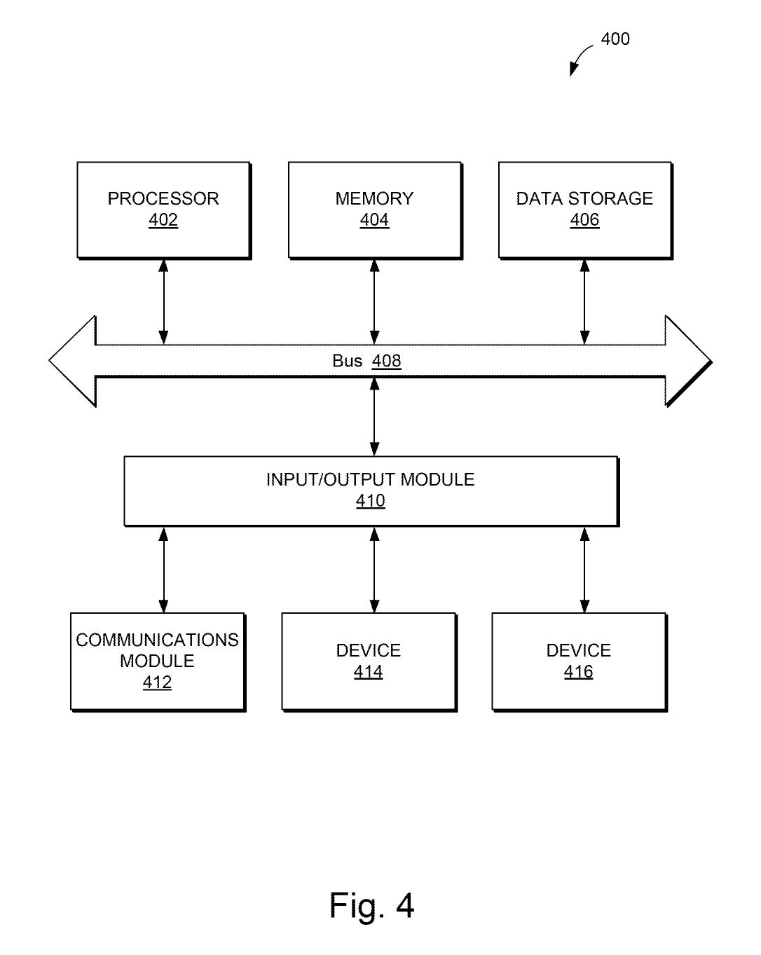

FIG. 4 is a block diagram illustrating an example computer system 400 with which a client device 110, and server 120 of FIG. 1 may be implemented. In certain aspects, the computer system 400 may be implemented using hardware or a combination of software and hardware, either in a dedicated server, or integrated into another entity, or distributed across multiple entities.

Computer system 400 includes a bus 408 or other communication mechanism for communicating information, and a processor 402 coupled with bus 408 for processing information. By way of example, the computer system 400 may be implemented with one or more processors 402. A processor may include one or more cores that may enhance speed and performance of a multiprocessor. In various embodiments, the processor may be a dual core processor, quad core processors, other chip-level multiprocessor and the like that combine two or more independent cores (called a die).

Computer system 400 can include, in addition to hardware, code that creates an execution environment for the computer program in question, e.g., code that constitutes processor firmware, a protocol stack, a database management system, an operating system, or a combination of one or more of them stored in an included memory 404 or any other suitable storage device, coupled to bus 408 for storing information and instructions to be executed by processor 402. The processor 402 and the memory 404 can be supplemented by, or incorporated in, special purpose logic circuitry.

The client may provide an interface to other devices including, without limitation, servers, other clients, printers, database servers, print servers, file servers, communication servers, distributed servers and the like. Additionally, this coupling and/or connection may facilitate remote execution of the program across the network. The networking of some or all of these devices may facilitate parallel processing of a program or method at one or more location without deviating from the scope of the disclosed subject matter. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The technologies described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The technologies described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, EVDO, mesh, or other networks types.

The technologies described herein may be implemented on or through mobile devices. The mobile devices may include navigation devices, cell phones, mobile phones, mobile personal digital assistants, laptops, palmtops, netbooks, ultrabooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code, programming instructions or programming language, may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The instructions may be stored in the memory 304 and implemented in one or more computer program products, i.e., one or more modules of computer program instructions encoded on a computer readable medium for execution by, or to control the operation of, the computer system 300.

Computer system 400 illustrated in Fig. further includes a data storage device 406 such as a magnetic disk or optical disk, coupled to bus 408 for storing information and instructions. Computer system 400 may be coupled via input/output module 410 to various devices. The input/output module 410 can be any input/output module. Example input/output modules 410 include data ports such as USB ports. The input/output module 410 is configured to connect to a communications module 412. Example communications modules 412 include networking interface cards, such as Ethernet cards and modems. In certain aspects, the input/output module 410 is configured to connect to a plurality of devices, such as an input device 414 and/or an output device 416. Example input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 416 include display devices, such as a CRT (cathode ray tube) or LCD (liquid crystal display) monitor, for displaying information to the user.

Various aspects of the subject matter described in this specification can be implemented in a computing system that includes a back-end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network, such as communication networks 230a, 230b in FIG. 2. The communication network (e.g., networks 230a, 230b) can include, for example, any one or more of a personal area network (PAN), a local area network (LAN), a campus area network (CAN), a metropolitan area network (MAN), a wide area network (WAN), a broadband network (BBN), the Internet, and the like. Further, the communication networks can include, but are not limited to, for example, any one or more of the following network topologies, including a bus network, a star network, a ring network, a mesh network, a star-bus network, tree or hierarchical network, or the like. The communications modules can be, for example, modems or Ethernet cards.

As discussed above, computing system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a personal digital assistant (PDA), a mobile audio player, a Global Positioning System (GPS) receiver, a video game console, and/or a television set top box.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

Alternative implementations of the subject matter could include the client simply sending a URL for a particular web page to the server, rather than selecting links from a web page and sending all of those links to the server. In this alternative implementation, the server itself could go to the requested web page and perform a check of all of the links on that web page. In yet another alternative implementation, when an inactive link is discovered, an alternative link could be provided to a cached or backup copy on the internet. Other variations are within the scope of the following claims.

1. An apparatus that visually presents inactive links on a web page to a user, the apparatus comprising:
a link resolution utility configured to create a list of one or more links on the web page after the user accesses the web page;
a disambiguation utility configured to receive the list of one or more links from the link resolution utility and determine whether any of the one or more links on the web page are inactive links;
a link updating utility configured to determine alternate links corresponding to at least a portion of any inactive links determined by the disambiguation utility and create a modified list of links including at least the alternate links; and
a modified link presenter configured to visually present to the user inactive links and any alternate links in a manner that reveals to the user statuses of the links, wherein the inactive links, any alternate links, and active links are visibly distinguishable from each other.

2. The apparatus according to claim 1, wherein:
the link resolution utility is configured to send a uniform resource locator of the web page to the disambiguation utility, and the disambiguation utility is configured to process the web page to determine the list of one or more links rather than receive the list of the one or more links from the link resolution utility.

3. The apparatus of claim 1, further including:
a delinkifying utility configured to remove a link attribute of each link discovered to be inactive.

4. The apparatus according to claim 1, wherein:
the disambiguation utility is further configured to attempt to check a destination address of each of the one or more links asynchronously.

5. The apparatus according to claim 1, wherein:
the disambiguation utility is further configured to attempt to ping a destination address of each of the one or more links on demand.

6. The apparatus according to claim 1, further including:
a modified link resolver configured to receive the modified list of links from the link updating utility and identify differences between the modified list and a list of link destination addresses present on the web page when the user connects to the web page; and wherein
the modified link presenter is configured to receive data regarding the differences identified by the modified link resolver and present inactive links in a visibly distinguishable manner from active hypertext links.

7. The apparatus according to claim 6, wherein:
the modified link presenter is further configured to cause one or more of the inactive links to display a status message to the user upon hovering of a pointer over the one or more of the inactive links.

8. The apparatus according to claim 6, wherein:
the modified link presenter is further configured to remove a link attribute of each of the inactive links and display a visual presentation that differs from another visual presentation of the active links, and clicking on one of the inactive links does not result in any attempt to navigate to linked content.

9. The apparatus according to claim 8, wherein:
the modified link presenter is further configured to cause modification of a hypertext markup language document object model associated with each of the inactive links in order to remove a link attribute of each of the inactive links.

10. The apparatus according to claim 1, wherein:
the modified link presenter is further configured to present inactive links with one of dashed or dotted underlining and any alternate links with a remaining one of dashed or dotted underlining to visibly distinguish the inactive links, the active links, and any alternate links from one another.

11. The apparatus according to claim 1, further including:
the modified link presenter is further configured to cause each alternate link to present text that notifies the user of an update from a previously inactive link corresponding to the alternate link.

12. The apparatus according to claim 11, wherein:
the modified link presenter is configured to cause the presentation of the alternate links after a user connects to the web page and the alternate links remain active links that result in navigation to alternate web sites when a user clicks on the alternate links.

13. The apparatus according to claim 1, further including:
the modified link presenter is further configured to present text of each inactive link without a determined alternate link in a visually distinct manner from text of each inactive link with a determined alternate link.

14. A client device that enables user notification regarding status of a link of a web page, the client device comprising:
a disambiguation utility configured to:
receive one or more link destination addresses present on the web page when a user accesses the web page,
attempt to ping each of the one or more link destination addresses after the user accesses the web page,
return a modified list of links for presentation to the user that include one or more of active and responding links and alternate links for inactive links and irrelevant links;
a delinkifying utility configured to remove a link attribute of each link discovered to be inactive after the attempt to ping each of the one or more link destination addresses by the disambiguation utility; and
a link updating utility configured to return a modified list of links comprising one or more of inactive links, active links, and alternate links, or some combination thereof, for presentation to the user in a manner that reveals to the user the status of the links, wherein a first text of the inactive links, a second text of any alternate links, and a third text of active links are visibly distinguishable from each other.

15. A server that enables user notification regarding status of a link of a web page, the server comprising:
a disambiguation utility configured to:
receive one or more link destination addresses present on the web page when a user accesses the web page,
attempt to ping each of the one or more link destination addresses after the user accesses the web page,
return a modified list of links for presentation to the user that include one or more of active and responding links and alternate links for inactive links and irrelevant links;
a delinkifying utility configured to remove a link attribute of each link discovered to be inactive after the attempt to ping each of the one or more link destination addresses by the disambiguation utility; and
a link updating utility configured to return a modified list of links comprising one or more of inactive links, active links, and alternate links, or some combination thereof, for presentation to the user in a manner that reveals to the user the status of the links wherein any alternate links and the active links are visibly distinguishable from each other.

16. A method for providing dynamically updated hypertext links on a web page to a user on demand, the method comprising:
receiving one or more link destination addresses for the hypertext links present on a web page after a user accesses the web page;
attempting to ping each of the link destination addresses for the hypertext links after the user accesses the web page;
returning a modified list of link destination addresses for presentation on the web page based on results of attempting to ping each of the link destination addresses;
determining alternate links corresponding to at least a portion of any inactive links determined during the attempting to ping each of the link destination addresses;
adding the alternate links to the modified list of link destination addresses; and
selectively modifying appearances of select hypertext links on the web page as a function of results of attempting to ping each of the link destination address after the user accesses the web page, wherein a first text of active links, a second text of any inactive links and a third text of the alternate links are displayed differently from one another.

17. The method according to claim 16, wherein:
the attempting to ping each of the link destination addresses for the hypertext links occurs asynchronously.

18. The method according to claim 16, wherein:
modifying the appearances of select hypertext links on the web page comprises presentation of text notifying the user of a change in status of the select hypertext links.

19. The method according to claim 16, wherein:
a link attribute is removed from each link that is determined to be inactive after attempting to ping a corresponding link destination address and a visual presentation is displayed that differs from another visual presentation of active links, and clicking on an inactive link does not result in any attempt to navigate to linked content.

20. The method according to claim 16, wherein:
selectively modifying the appearances of select hypertext links comprises one or more of presentation of text with dotted or dashed underlining, presentation of text with a different font, presentation of text with bolding, presentation of text with italicizing, or presentation of text with a different color.

21. The method according to claim 16, further including:
asynchronously pinging each hypertext link on a web page when a user accesses the web page and before the user clicks on any of the hypertext links.

22. (canceled)

23. The method according to claim 16, wherein:
each link that is determined to be inactive and without any alternate links after attempting to ping a corresponding link destination address displays a visual presentation that differs from another visual presentation of an inactive link for which an alternate link is found.

24. One or more computer-readable media storing processor-executable instructions that, when executed, cause one or more processors to perform operations that facilitate dynamically updating hypertext links on a web page, the operations comprising:
receiving one or more link destination addresses for the hypertext links present on a web page after a user accesses the web page;
attempting to ping one or more of the link destination addresses for the hypertext links after the user accesses the web page;
determining alternate links corresponding to at least a portion of any inactive links determined during the attempting to ping each of the link destination addresses;
adding the alternate links to a modified list of link destination addresses;
returning the modified list of link destination addresses for presentation on the web page based on results of attempting to ping one or more of the link destination addresses; and
selectively modifying appearances of select hypertext links on the web page as a function of results of attempting to ping one or more of the link destination address after the user accesses the web page, wherein a first text of active links and a second text of the alternate links are displayed differently from one another.

25. One or more computer-readable media as recited in claim 24, the operations further comprising:
the attempting to ping one or more of the link destination addresses for the hypertext links occurs asynchronously.

26. One or more computer-readable media as recited in claim 24, the operations further comprising:
modifying the appearances of select hypertext links on the web page comprises presentation of text notifying the user of a change in status of the select hypertext links.

27. One or more computer-readable media as recited in claim 24, the operations further comprising:
removing a link attribute of a link that is determined to be inactive after attempting to ping a corresponding link destination address, displaying a visual presentation that differs from another visual presentation of active links, and discontinuing any attempt to navigate to linked content when clicking on an inactive link.

28. One or more computer-readable media as recited in claim 24, the operations further comprising:
selectively modifying the appearances of select hypertext links comprises one or more of presenting the text of the select hypertext links with dotted or dashed underlining, presenting the text with a different font, presenting the text with bolding, presenting the text with italicizing, or presenting the text with a different color.

29. (canceled)

30. One or more computer-readable media as recited in claim 24, wherein:
each link that is determined to be inactive and without any alternate links after attempting to ping a corresponding link destination address displays a visual presentation that differs from the visual presentation of an inactive link for which an alternate link is found.

31. The apparatus of claim 1, wherein the link updating utility is further configured to determine alternate links corresponding to the at least the portion of any inactive links by searching a database of web pages in a same site as each of any inactive links for the at least the portion of each of any inactive links.

32. The apparatus of claim 31, wherein the at least the portion of any inactive links comprises a portion of a uniform resource locator (URL) of any inactive links.
